(19) United States
(12) Patent Application Publication
(10) Pub. No.: US 2005/0106301 A1
(43) Pub. Date: May 19, 2005

(54) Method and apparatus for cryogenically manufacturing ice cream

(76) Inventor: Curt Jones, Brentwood, TN (US)

Correspondence Address: STOCKWELL & ASSOCIATES, PSC, 861 CORPORATE DRIVE, SUITE 201, LEXINGTON, KY, 40503, US

(21) Appl. No.: 10/950,053

(22) Filed: Sep. 24, 2004

Related U.S. Application Data
(60) Provisional application No. 60/505,641, filed on Sep. 24, 2003.

(51) Int. Cl. A23B 4/00

(52) U.S. Cl. 426/524

(57) ABSTRACT

An apparatus and method for cryogenically manufacturing ice cream is disclosed.

### CROSS-REFERENCE TO RELATED APPLICATIONS

This application claims priority to U.S. Provisional Patent Application No. 60/505,641, which was filed on Sep. 24, 2003.

### FIELD OF THE INVENTION

The present invention relates to ice cream and more particularly to an apparatus and method for cryogenically manufacturing ice cream.

### BACKGROUND OF THE INVENTION

Conventional ice cream has existed for many years in many embodiments. However, manufacturing ice cream often requires extensive time in complex rotary barrel and hardening freezers. These devices can require expensive and complicated equipment to operate and maintain, such as compressors, evaporators, motors, condensers, and other equipment. FIG. 1 shows a prior art barrel freezer arrangement having these features. A barrel 38 has a cylindrical opening 56 in which ice cream mix is inserted. The barrel mechanism is contained within an evaporator 20, which is connected in series with a shutoff valve 24, a filter 28, a condenser 30, a compressor 32, an accumulator 34, and an emergency pressure release (EPR) valve 36.

Also, such rotary mechanisms tend to freeze ice cream slowly, and from the outside in, so that large ice crystals are formed therein. If ice crystals formed during the freezing process are too large, the taste and mouthfeel of the ice cream can be watery and diluted. Consequently, a method and apparatus for using cryogenics to freeze ice cream from the inside out is desired.

### BRIEF SUMMARY OF THE INVENTION

This invention has as its primary objective a method and apparatus for cryogenically freezing ice cream that does not require or greatly reduces the requirement for the equipment and complexity typically associated with a rotary barrel style ice cream freezer and hardening chamber or hardener, and that freezes from the outside in rather than from the inside out. A further objective of the present invention is to achieve the freezing process more quickly and save on electricity.

These and other objects and advantages of the invention will become readily apparent as the following description is read in conjunction with the accompanying drawings and claims.

### BRIEF DESCRIPTION OF THE DRAWINGS

FIG. 1 shows a prior art prior art barrel freezer arrangement;

FIG. 2 shows a first embodiment of the present invention;

FIG. 3 shows a barrel freezer of the present invention;

FIG. 4 shows a second embodiment of the present invention; and

FIG. 5 shows a third embodiment of the present invention.

### DETAILED DESCRIPTION OF THE PREFERRED EMBODIMENTS

Before explaining the disclosed embodiment of the present invention in detail it is to be understood that the invention is not limited in its application to the details of the particular arrangement shown, since the invention is capable of other embodiments. Also, the terminology used herein is for the purpose of description and not of limitation.

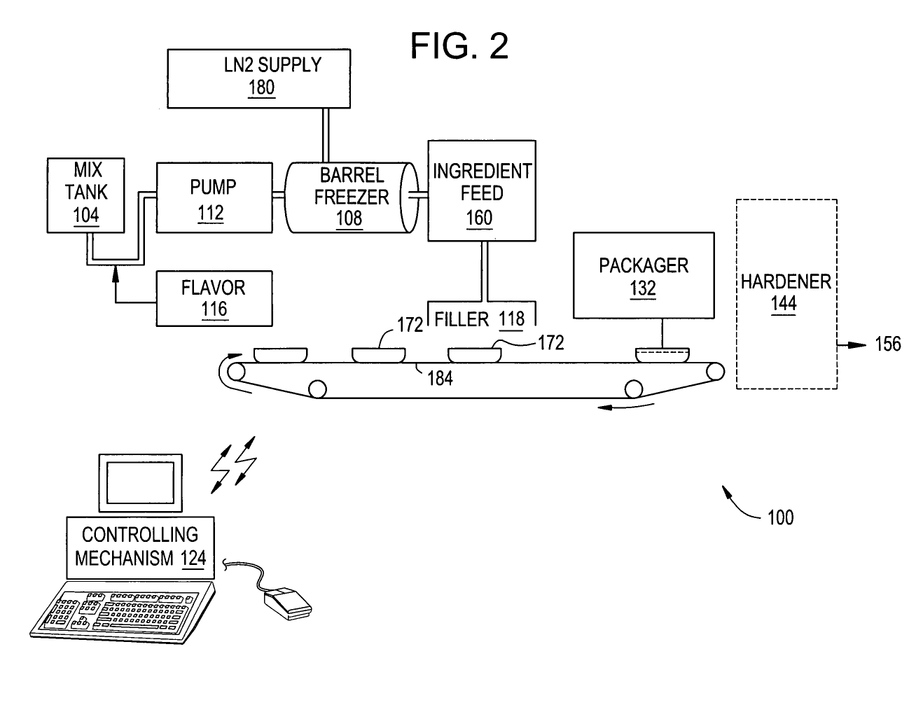

A system 100 for cryogenically manufacturing ice cream is shown in FIG. 2, wherein all recited devices are responsive to a central controlling mechanism 124 such as a computer. The mechanism 124 can either be in direct proximity to the system 100, or can be located offsite and communicate wirelessly with the various devices that comprise the system 100.

Multiple separate production systems 100 such as that shown in FIGS. 2, 4, and 5 may be employed, each dedicated to one or a limited number of flavors or ingredients. However, separate dedicated systems are expensive and consume a great deal of factory floor space and energy.

The process of making of ice cream starts with liquid ingredients, including dairy products, being delivered to a mix tank 104 and blended therein. The blended liquids are conveyed to a rotary barrel freezer 108 where mixing continues and the mixed ingredients are chilled. Unlike the barrel freezers of the prior art, this chilling is achieved cryogenically through a variety of means, including a supply 180 for blowing or sputtering cryogenic air through the ice cream mixture while it is whipped or agitated. Within the present invention, the air from the supply 180 can include a cryogenic gas such as Liquid Nitrogen (LN2) with a nitrogen percentage such as but not limited to 80%. LN2 is advantageous because it is liquid at atmosphere pressure at temperatures below −320° F. (−195.8° C.), and is completely sanitary and can be applied directly to food products. However, other cryogenic gases could also be used, but potentially would require modifications to the system 100 of the present invention.

The forced movement of such exceptionally cold air assists in freezing the ice cream with smaller ice crystals that are more effectively dispersed. This in turn results in a less watery, less diluted frozen product which is tastier and has a smoother texture and mouthfeel.

Within all embodiments of the present invention, the LN2 can come from bulk tanks or supplys 180a-d which must occasionally be purged or let off some discharge, particularly during long periods of disuse. Because the LN2 stored therein is so exceptionally cold, atmospheric heat from normal room temperature storage can lead to a buildup of pressure within the supplys 180a-d. Consequently, channeling the excess LN2 could lead to additional cost savings because the expectation is that in any LN2 storage, some discharge will inevitably occur. It is advantageous to channel that inevitable LN2 discharge into some productive use.

Within the barrel freezer 108, the mixed ingredients are chilled to a temperature of 0°-17° F., although the present invention should not be considered as limited to this temperature only. Consequently, all equipment shown in the embodiments of FIGS. 2, 4, and 5 must be ruggedized to operate at such low temperatures.

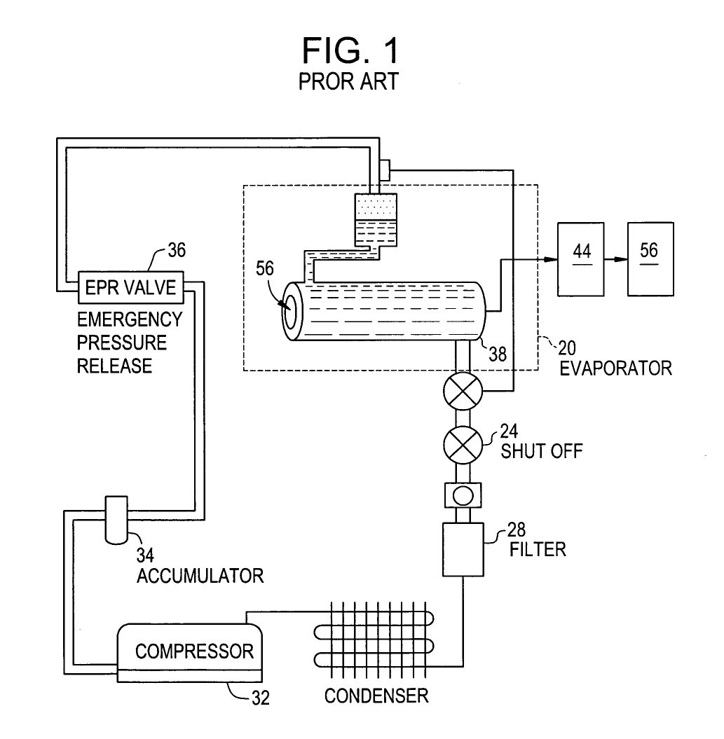

Additionally, existing prior art implementations tended to keep the semi-soft ice cream mix at 20° F. until it reaches the hardening chamber. This was partly so less ruggedized and lower horsepower equipment could be used, but also because the ice cream mix is somewhat easier to handle at this temperature, having a lower viscosity. As shown in FIG. 1, these prior art implementations depended on the final freezing to take place in an expensive hardening chamber 44, which the present invention either eliminates or greatly reduces.

It is true that the semi-solid ice cream still must be pumpable and manageable before going into the container 172. However, the aerated and pre-hardened ice cream of the present invention needn't be completely hardened before going into the container 172, although it will have a high viscosity and thus a high resistance to movement, likely higher than in mechanisms of the prior art. Accordingly, the present invention will require equipment capable of generating high torque and thus will probably need significant horsepower and possibly a transmission or some type of torque conversion means.

For example, using N2 gas and LN2 within the system 100 of the present invention as described herein, the ice cream mix 0-17° F. could still move, but would be more resistant to movement. Despite this, it is still an advantage that the ice cream mix at 0-17° F. is sufficiently cold to go directly into the inventory freezer 156, so that no hardening chamber 144 is necessary.

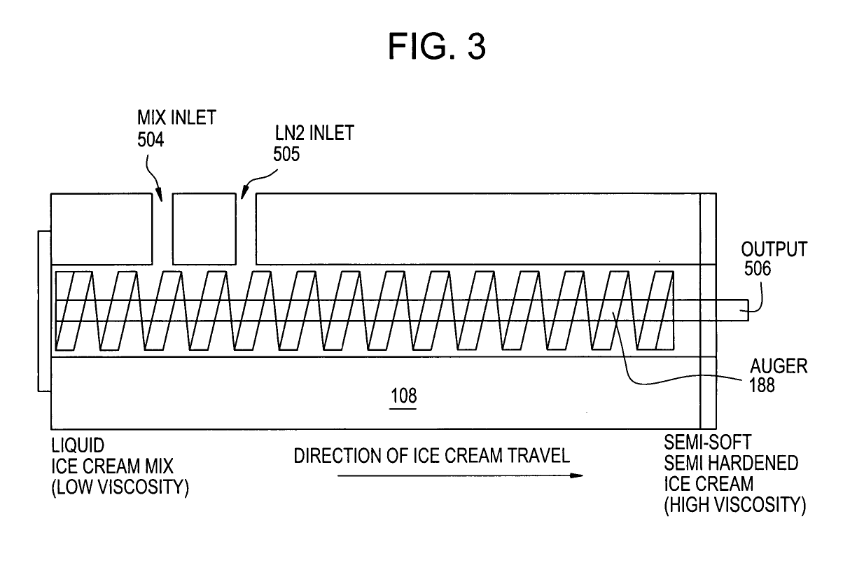

The rotary barrel freezer 108 is shown in more detail in FIG. 3. The low-viscosity ice cream mix enters at the left side of the barrel 108 through input valves 504, while cryogenic air such as LN2 enters through valves 505. The barrel 108 can be continually rotated so that the liquid ice cream mix is under constant motion. Because of this constant motion, at any given time some low viscosity still-liquid mix is sloshing up the sides of the interior surface of the barrel 108 as the barrel rotates. Because the surfaces of the barrel 108 are maintained at extremely low temperature, when the ice cream mix makes contact with the barrel 108, the ice cream mix freezes and solidifies to some extent. Simultaneously, cryogenic air can also whipped or agitated into the liquid ice cream mix, both inside the barrel 108 and potentially within the mix tank 104. Although the specific connection mechanism by which the cryogenic air is introduced directly into the ice cream mix is not shown, the intended effect is to aerate or pre-aerate the ice cream mix before or while it is being frozen.

Within the present invention, it is also contemplated that the freezing barrel 108 may not rotate at all. The complexity and rigor of hooking extra tubes, nozzles, and measurement equipment onto a rotating barrel 108 may not be necessary. It may be possible instead for the barrel 108 to remain stationary, since the auger 188 is providing the left-right movement, and also because the actual freezing is occurring more through the LN2 nozzles 505 and less through contact with the side-surfaces of the barrel 108. In either case, the auger 188 or some other type of propulsion or scraping means moves the higher-viscosity frozen material from left to right, eventually being outputted through the output valves 506.

A comparison of FIGS. 1 and 3 shows that the barrel freezer 108 of the present invention (FIG. 3) is considerably less complicated than the prior art mechanism of FIG. 1. Unlike the prior art shown in FIG. 1, no compressors or evaporators or mechanical amplifiers are needed with bulk tanks 180 of LN2. These bulk tanks can use gravity-feed principles, and sometimes create their own pressure just by sitting outside and doing nothing. However, it is contemplated within the spirit and scope of the present invention that the two could be combined in various proportions. The addition of the LN2 mechanisms of FIG. 3 to the FIG. 1 embodiment could still provide considerable cost, energy, and time savings over the unaltered mechanisms of FIG. 1 alone by themselves.

Within the system 100 of the present invention, it is desired to have a large proportion of LN2 make contact with the liquid ice cream mix. This is because an overabundance of N2 gas bubbles could expand within the ice cream and cause huge overrun (undesired increase in volume and reduction in density), resulting in as much as 300% or 400% overrun. The resulting product would almost be like a whipped cream, fluffy and low-density, which is an undesired characteristic.

Thus, it is desired for at least some of the LN2 to stay liquid LN2 as long as possible, and not turn to gas N2. The exact proportion of gas/liquid can vary. LN2 can stay liquid if the surrounding metal of the nozzles and pipes are pre-cooled, and thus won't turn into gas until it directly hits the ice cream mix. In this way the desired amount of whipping or aerating or pre-aerating can be achieved, and is accomplished using both LN2 and N2, and not solely gas N2.

There is another way to reduce overrun, by controlling pressure within the freezing barrel 108. It is possible to entirely fill the freezing barrel 108 with liquid ice cream mix, and let off excess gas or increase gas, yet don't let out any of the high viscosity semi-soft ice cream. This way it is not possible for the ice cream product to expand in volume. One change in such an implementation is that the freezing barrel 108 may no longer rotate. In prior art barrel freezers, the ice cream was created by contact with the sides of the ever-rotating barrel, and then scraped from the sides as a semi-solid, and then moved from left to right within the barrel. Finally, the overrun problem could be overcome by using a combination of gas N2 and liquid LN2.

It is also important to manage the amount of refrigerant going into the barrel 108. In other words, it is important to regulate the volume of LN2 to match the volume of ice cream mix going thru the barrel 108. Too much LN2 and/or gas N2 means too much overrun, too little density, too much whipping and aeration. One way to do this is to measure and regulate the volume of gas coming out of the LN2 bulk tanks 180, but it is also possible to measure volume/pressure of ice cream mix. The second could be used as a check on the first, or vice-versa. Between the two measurement systems, it is possible to obtain an accurate reading of both volumes, and therefor manage the overrun to keep it within the desired guidelines, or to eliminate overrun entirely.

Using the cryogenic system 100 of the present invention, the improvement in quality of the resulting ice cream product will be noticeable. Also, eliminating the hardening chamber 144 will also generate significant savings in both time, package handling, equipment, electricity, and other measurable quantities too numerous to mention.

Returning to FIG. 2, at the output of the barrel freezer 108 is the ingredient feed 160, which selectively provides, if desired, solid ingredients such as cookies, candy, crackers, nuts, etc., and/or semi-solid or liquid ingredients such as caramel, fudge, peanut butter, chocolate, fruit products, cookie dough, sherbet, spices, marshmallow, as well as others, all responsive to the control mechanism 124. The still unfrozen ice cream mix is then conveyed through the ingredient feed 160 to a package filler 118. Flavors can be added to the ice cream mix prior to entry into the barrel freezer 108 through a flavor dispenser 116, or at a variety of other positions within the system 100. The ingredient feed 160 can optionally be used to add solid ingredients such as cookie pieces to the semi-frozen ice cream. The package filler 118 takes the still-soft (and thereby still manageable) ice cream material and fills it into consumer containers 172.

It will be further understood that flavor dispensers 116 are preferably capable of selectively dispensing one or more flavorings depending upon the desired end flavor mixture. For example, a dispenser 116 may hold cherry, strawberry, or chocolate flavoring ingredients, whether solid, cryogenically frozen, semi-solid, or liquid, in individual compartments or chambers within the dispenser 116. Because some of these flavorings by themselves may not be suited to cryogenic liquids and gases, the process controlling mechanism 124 can direct a flavor dispenser 116 to selectively dispense one or more of these flavoring ingredients either before or after the ice cream mix has been pre-hardened.

The package fillers 118 of the present invention are customized to be specific to a particular package. Thus, if filling half gallon rectangular cardboard “brick” containers, the package filler would be specifically designed to completely fill and close the one half gallon brick container. Alternatively, if filling half gallon or quart round tubs, a different package filler designed for such a package would be used.

In FIG. 2, as stated, the ice cream mix being filled at the package filler 118 is still soft enough to be manageable but is no longer an easily flowing, low viscosity liquid. The function of the package filler 118 includes filling the entire package completely and ensuring no air voids remain in any corners or apertures of the various packages.

As shown in FIG. 2, the semi-soft ice cream mix and the container 172 meet at the package filler 118 via a conveyor mechanism 184 which can have but does not require having rollers and a belt. In the case of half gallon bricks, the packages can be provided to the package filler 118 in a flat form. The filler 118 opens the packages, fills them and in some cases closes them. In the case of tubs, the plastic tubs are already three dimensional items and arrive to the filler 118 already opened.

After the container 172 is filled with ice cream mix, a lid must be placed upon it or its flaps must be closed. These functions are performed at the packager 132 where an optional shrink wrap may also be applied. Shrink wrapping can be done at this point to ease handling of the finished product and improve efficiency of the overall package-handling operation. Adding shrink wrap prior to hardening can also increase the resulting package's resistance to changes in temperature. In any case, whether shrink-wrapped or not, the packaged ice cream products are then conveyed to a hardener 144 where they will reside for varying times while the ice cream contained in the container is chilled and hardened. The exact durations of time spent in the hardening chamber 144 can be arrived at through experimentation, partially depending on the particular mix of ingredients.

One type of hardener 144 is a roller bed hardener, although the present invention should not be considered as limited exclusively thereto. Roller bed hardeners have roller conveyors inside of insulated rooms wherein chilled air is circulated to remove heat from the ice cream and chill the product down to a low temperature, typically 0° F. (−18° C.) or less. To accommodate these rollers and also have convenient access to the products contained therein, a very large room is required. Keeping such a room sufficiently cold can incur substantial energy costs.

A second type of hardener 144 is known as a contact plate freezer. Contact plate freezers work best with rectangular or cubic products having one or more flat surfaces such as half gallon cardboard ice cream containers, but don't work quite as well with round tubs. The containers are packed closely together and very cold aluminum plates are placed on the top and bottom of the containers chilling them by direct contact with the cold metal. The metal plates can be kept cold using cryogenic means such as direct application of LN2 to the plates, or can have electrical or electronic elements which cause the metal to consistently sustain low temperatures. The times necessary to reach appropriate hardening temperature vary. The hardeners 144 described above can be large and expensive to install and are thus most cost-effective with very large production runs. However, the size, complexities, and energy consumption of the hardener 144 can be reduced or even eliminated by using the pre-hardening techniques of the system 100 of the present invention.

Following the hardening process to completion, in all embodiments of the present invention the finished ice cream product is conveyed to an inventory freezer 156 prior to sale and shipping. In prior art systems such as that shown in FIG. 1, the hardening chamber 44 was set to get the containerized ice cream to 0° F. as quickly as possible. One way to achieve this was using a blast freezer as a hardener 44, having a wind-chill of for example −50° F. This has the problem of freezing from the outside in, therefore forming larger ice crystals, as well as the expense of the compressors and other equipment and the electricity necessary to run it. It is also important to note that such freezing was not to cause the ice cream to stay at 0° F., but merely to freeze it quickly. However, ice cream could still sit in a hardener 44 for as long as 12-24 hours. After hardening but prior to shipping, the ice cream then was moved to an inventory freezer 56 which is maintained at −20° F. Quality control and other inspections are performed at this inventory freezer 56.

As shown in FIGS. 2, 4, and 5, the present invention still uses the inventory freezer 156, but would bypass or reduce the need for the expensive and time-consuming hardening chamber 144 (shown in dotted lines) because as stated the ice cream mix at 0-17° F. is sufficiently cold to go directly into the inventory freezer 156.

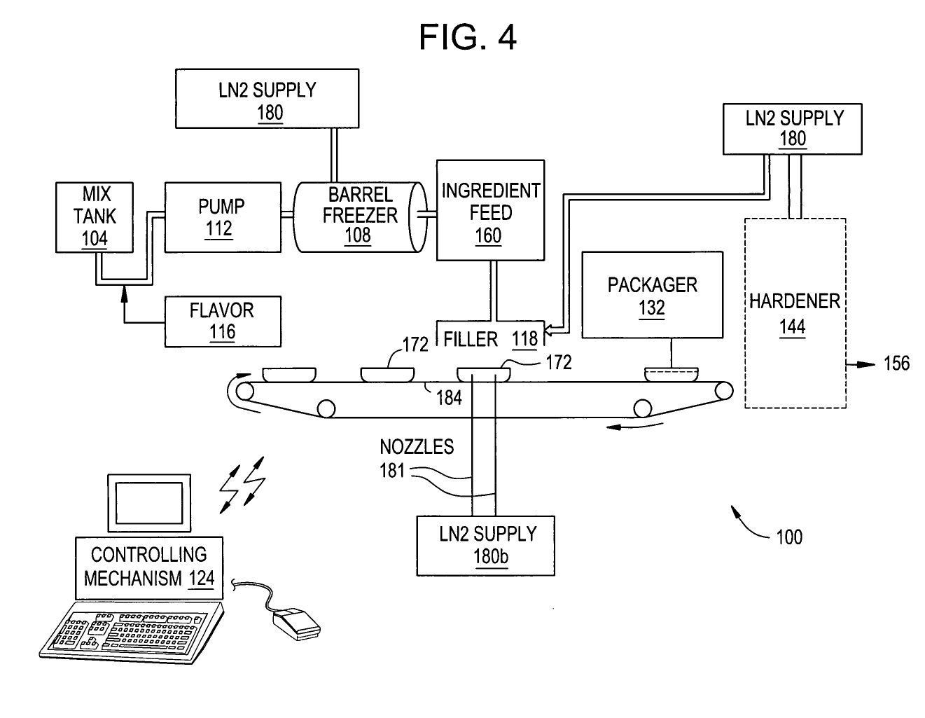

FIG. 4 illustrates a second embodiment of the present invention, again with a mix tank 104, a rotary barrel freezer 108, a pump 112, and an ingredient feed 160. The semi-liquid ice cream (with or without solid ingredients) exiting the ingredient feed 160 is again directed to a filler 118. The embodiment of FIG. 4 introduces cryogenic advantages into additional portions of the system 100, as shown by the LN2 supplys 180a, 180b, and 180c.

As stated, the filler 118 acts to completely fill the containers 172 in a quick automated manner. However, FIG. 4 shows a hardener 144 which is also modified to use cryogenic gas rather than the cold air of the FIG. 4 embodiment. As shown in FIG. 4, the cryogenic hardener 144 uses LN2 as a cooling agent, although as stated other cryogenic gases could also be used. Also as shown in FIG. 4, LN2 can be forced directly into the ice cream in the container 92 through nozzles 181, thereby extracting heat from the ice cream mix. The LN2 quickly vaporizes upon injection, so that cold vapor circulates within the ice cream mix at extremely low temperature thereby more quickly hardening it. This has the effect of creating small, evenly dispersed ice crystals within the ice cream. Like in FIG. 2, the cryogenic gas can also be applied to the ice cream mix while still in the barrel freezer 108, but also can be sprayed onto the containerized ice cream without using the nozzles 181.

In the embodiment where the nozzles 181 are in direct contact with the ice cream mix inside the container 172, the nozzles can be operated at a pressure and velocity sufficiently low that the ice cream mix is not spattered or splashed outside the container. A diffusion mechanism (not shown) such as a bayonet fitting or other type of pressure regulator can be attached to the surface of the nozzle 181 so that unwanted gusts of LN2 and the resultant spattering of ice cream do not occur, and instead the flow of LN2 is carefully regulated.

In an alternative embodiment, the nozzles 181 and the blown air therefrom can cause a limited, controlled amount of tunneling or holes into the actual finished ice cream product. The supercooled product could have a tunneled, swiss cheese type of look and finish, although taste and texture would not be affected. Because ice cream is sold by weight, a slightly larger package can be used to accommodate the product's increased volume which results from the tunnels and or holes caused by the nozzles 181, yet still maintain a chosen specific product weight per unit. Thus, a customer would not be paying a premium for all the extra air in their package. In such an embodiment, the package filler 118 described earlier would be altered so as to not act to remove air voids in the container 172.

The nozzles 181 can also act as temperature probes, or have adjoining temperature probes attached therewith, so as to feed back information to the centralized controlling mechanism 124 which can make decisions about sufficiency of frozenness. As stated, the controlling mechanism 124 can be located near the hardening chamber 144, but also can be located off-site and communicate wirelessly with a relay mechanism (not shown) in direct mechanical and electrical contact with the nozzles/probes 181 or other devices within the system 100. Again, all such computer and communication equipment must be sufficiently ruggedized to withstand these extremely low temperatures.

In such an environment, the hardening time required of any ice cream product is greatly reduced, so that the hardener 144 may not be necessary at all (hence the dashed lines in FIG. 4). Also, supposing the belt of the conveyer 184 was sufficiently wide, the ice cream products and their containers could be arranged so that several products proceed abreast through the hardener 144 (supposing one is necessary). In the configuration where the nozzles 181 are not used, the effectiveness of spraying cryogenic gas onto the ice cream mix is optimized when the filled container to be frozen has a large surface area upon which the cryogenic gas may act, and the volume of material requiring hardening contained therein is small. Thus, containers which maximize the ratio of surface area to volume work well within the present invention, although the present invention should not be considered as limited thereto.

Additionally, within the configuration shown in FIG. 4, cryogenic hardening can begin while the container 172 is still open. In FIG. 4, the cryogenic freezing action is shown as occurring directly on the ice cream product through the nozzles 181, although the present invention should not be considered as limited exclusively thereto. Alternatively or jointly, the closed container can also be sprayed with cryogenic gas, either with or without shrink-wrapping. Because the cryogenic gas is at an extremely low temperature, hardening the ice cream container 172 even before the lid is applied is completely sanitary and hygienic. Moreover, the extremely rapid hardening produces an ice cream product having superior texture characteristics, in that the ice crystals formed therein are smaller and more evenly dispersed.

If solid ingredients are used, they may be cryogenically frozen into chunks, pieces, particles, or beads prior to being incorporated inside the ice cream at ingredient feed 160. Thus, the ice cream product can be frozen from the inside out, as well as from the outside in using the techniques and equipment described herein. A mechanism for cryogenically freezing ice cream into ultra-cold beads is shown in U.S. Pat. No. 5,126,156, the contents of which are hereby incorporated by reference.

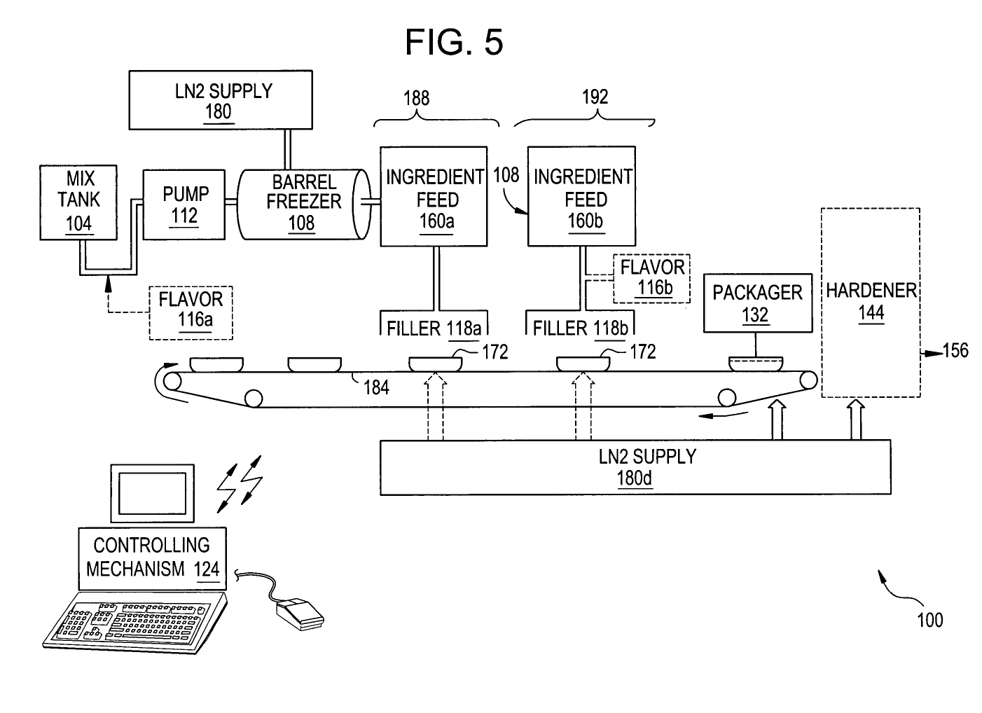

Referring now to FIG. 5, another embodiment of an ice cream manufacturing and packaging system and process is shown in which multiple pre-hardening stages 188, 192 are employed. Two such pre-hardening stages are shown, although more stages could be used. The stages 188, 192 are shown in FIG. 5 as being connected in series. However, depending on space and energy considerations, they could be connected in parallel also. FIG. 5 also shows LN2 supplys 180a and 180d being arranged differently than either FIG. 2 or 4. Other variations and locations of LN2 supplys are also contemplated within the spirit and scope of the present invention.

It is an advantage of the embodiment shown in FIG. 5 that flavoring ingredients may be added at any stage. To that end, FIG. 5 includes a flavor dispenser 116 before the first pre-hardening stage 188 and the packager 132, although that configuration is but exemplary and the present invention should not be considered as limited exclusively thereto. Also, the barrel freezer 108 may connect to both stages 188 and 192, or these stages may each have separate tanks, coolers, pumps, etc.

The various aspects of the present invention has been described in detail with particular reference to preferred embodiments thereof, but it will be understood that variations and modifications can be effected within the spirit and scope of the invention as described herein. It is anticipated that various changes may be made in the arrangement and operation of the system of the present invention without departing from the spirit and scope of the invention, as defined by the following claims.

1. A method of cryogenically freezing ice cream, comprising:
filling a mix tank with semi-solid liquid ice cream mix;
transporting said mix to a barrel freezer;
whipping and aerating the ice cream while inside said barrel freezer by sputtering or injecting a combination of cryogenic liquid and gas, thereby achieving a pre-hardening effect on said mix;
containerizing said ice cream mix;
closing a lid of said container; and
storing said combination for sale or distribution.

2. The method of claim 1, further comprising:
inputting said mix into said barrel freezer as a low viscosity liquid; and
outputting said mix from said barrel freezer as a high viscosity semi-solid.

3. The method of claim 1, further comprising:
intermixing solids within said ice cream mix prior to said containerizing step.

4. The method of claim 3, further comprising:
cryogenically freezing said solids prior to said step of intermixing.

5. The method of claim 1, further comprising:
arranging a plurality of said containers to be positioned to maximize effect and utility of said cryogenic gas spray.

6. The method of claim 1, further comprising:
hardening said combination for a pre-determined period.

7. The method of claim 1, further comprising:
rotating said barrel freezer.

8. The method of claim 1, further comprising:
pressurizing said barrel freezer, thereby reducing overrun characteristics of said mix.

9. The method of claim 1, further comprising:
inserting nozzles into said mix while contained within said container; and
injecting cryogenic gas through said nozzles.

10. The method of claim 8, further comprising:
observing the temperature of said mix using temperature probes incorporated within said nozzles.

11. The method of claim 1, further comprising:
governing all steps responsive to a centralized controlling mechanism.

12. The method of claim 1, wherein said cryogenic liquid and gas contains liquid nitrogen.

13. The method of claim 1, wherein said cryogenic liquid and gas is 80% nitrogen.

14. The method of claim 1, wherein said mix is frozen from the inside out.

15. The method of claim 1, further comprising:
monitoring and adjusting the ratio of cryogenic liquid to cryogenic gas, thereby reducing overrun.

16. The method of claim 1, further comprising:
shrink-wrapping said container prior to said hardening step.

17. A method of cryogenically freezing ice cream, comprising:
filling a mix tank with semi-solid liquid ice cream mix;
transporting said mix to a barrel freezer;
whipping and aerating the ice cream while inside said barrel freezer by sputtering or injecting a combination of cryogenic liquid and gas, thereby achieving a pre-hardening effect on said mix;
containerizing said ice cream mix;
further pre-hardening said mix;
closing a lid of said container; and
storing said combination for sale or distribution.

18. The method of claim 17 further comprising:
inputting said mix into said barrel freezer as a low viscosity liquid; and
outputting said mix from said barrel freezer as a high viscosity semi-solid.

19. The method of claim 17 further comprising:
intermixing solids within said ice cream mix prior to said containerizing step.

20. The method of claim 19, further comprising:
cryogenically freezing said solids prior to said step of intermixing.

21. The method of claim 17 further comprising:
arranging a plurality of said containers to be positioned to maximize effect and utility of said cryogenic gas spray.

22. The method of claim 17, further comprising:
hardening said combination for a pre-determined period.

23. The method of claim 17, further comprising:
rotating said barrel freezer.

24. The method of claim 17 further comprising:
pressurizing said barrel freezer, thereby reducing overrun characteristics of said mix.

25. The method of claim 17, further comprising:
inserting nozzles into said mix while contained within said container; and
injecting cryogenic gas through said nozzles.

26. The method of claim 25, further comprising:
observing the temperature of said mix using temperature probes incorporated within said nozzles.

27. The method of claim 17, further comprising:
governing all steps responsive to a centralized controlling mechanism.

28. The method of claim 17, wherein said cryogenic liquid and gas contains liquid nitrogen.

29. The method of claim 17 wherein said cryogenic liquid and gas is 80% nitrogen.

30. The method of claim 17, wherein said mix is frozen from the inside out.

31. The method of claim 17, further comprising:
monitoring and adjusting the ratio of cryogenic liquid to cryogenic gas, thereby reducing overrun.

32. The method of claim 17, further comprising:
shrink-wrapping said container prior to said hardening step.

33. A method of cryogenically freezing ice cream, comprising:
filling a mix tank with semi-solid liquid ice cream mix;
transporting said mix to a barrel freezer;
whipping and aerating the ice cream while inside said barrel freezer by sputtering or injecting a combination of cryogenic liquid and gas, thereby achieving a pre-hardening effect on said mix;
containerizing said ice cream mix;
closing a lid of said container; and
storing said combination for sale or distribution.

34. The method of claim 33, further comprising:
inserting nozzles into said mix while contained within said container; and
injecting cryogenic gas through said nozzles.

35. The method of claim 34, further comprising:
observing the temperature of said mix using temperature probes incorporated within said nozzles.

36. The method of claim 34, further comprising:
governing all steps responsive to a centralized controlling mechanism.

37. The method of claim 34, further comprising:
injecting said cryogenic gas in such a way as to create permanent tunnels and holes in the ice cream mix.
